(19) United States
(12) Patent Application Publication
(10) Pub. No.: US 2012/0182292 A1
(43) Pub. Date: Jul. 19, 2012

(54) APPARATUS AND METHOD FOR DISPLAYING STEREOSCOPIC IMAGES

(76) Inventors: Kenichi Shimoyama, Tokyo (JP); Takeshi Mita, Yokohama-shi (JP); Masahiro Baba, Yokohama-shi (JP); Ryusuke Hirai, Tokyo (JP); Rieko Fukushima, Tokyo (JP); Yoshiyuki Kokojima, Yokohama-shi (JP)

(21) Appl. No.: 13/361,148

(22) Filed: Jan. 30, 2012

Related U.S. Application Data
(63) Continuation of application No. PCT/JP2010/070815, filed on Nov. 22, 2010.

(51) Int. Cl. G06T 15/00

(52) U.S. Cl. 345/419

(57) ABSTRACT

According to an embodiment, a stereoscopic image displaying apparatus is configured to display a multi-viewpoint image. An acquirer acquires person data including a position of each of at least one person viewing a stereoscopic image, a calculator calculates a weight from (1) the person data and (2) display parameters, the weight representing a stereoscopic degree inferred, for each of the at least one person, from a multi-viewpoint image to be displayed in accordance with the display parameters, a determiner selects the display parameter based on the weights, and generates a multi-viewpoint image that accords with the display parameters selected, and a displaying device displays the generated image.

### CROSS-REFERENCE TO RELATED APPLICATIONS

This application is a Continuation Application of PCT Application No. PCT/JP2010/070815, filed Nov. 22, 2010, the entire contents of which are incorporated herein by reference.

### FIELD

Embodiments described herein relate generally to an apparatus and method for displaying stereoscopic images.

### BACKGROUND

Any stereoscopic image display apparatus, with which no dedicated eyeglasses are used, has a limited display field (hereinafter called “view region”) where a stereoscopic image can be seen. A viewer may have difficulty viewing a stereoscopic image, depending on their position with respect to the stereoscopic image display apparatus. Even if a viewer initially stays in the view region, he or she may move away from the view region. Therefore, it is desirable to change the mode of displaying the stereoscopic image in accordance with the viewer's position, so that the viewer may see the stereoscopic image. Even if there are several viewers, it is also desirable to change the mode of displaying the stereoscopic image.

### BRIEF DESCRIPTION OF THE DRAWINGS

FIG. 1 is a block diagram of a stereoscopic image display apparatus according to an embodiment;

FIG. 2 is a perspective view schematically showing an exemplary configuration of the image display apparatus according to an embodiment;

FIG. 3 is a block diagram schematically showing a configuration of a weight calculator and image determiner according to an embodiment;

FIG. 4 is a block diagram showing a configuration of the person data acquirer;

FIG. 5 is a block diagram showing a weight calculator according to an embodiment;

FIG. 6 is a diagram explaining how a weight is calculated from an area of a region that can be seen as a stereoscopic image according to an embodiment;

FIG. 7 is a diagram explaining how a weight is calculated from the density of light beams according to an embodiment;

FIG. 8 is a diagram showing an exemplary weight map calculated by a weight calculator according to an embodiment;

FIG. 9 is a block diagram showing an image determiner according to an embodiment;

FIG. 10 is a diagram explaining display parameters controlling a view region according to an embodiment;

FIG. 11 is a diagram explaining display parameters controlling a view region according to an embodiment;

FIG. 12 is a diagram explaining an adjacent view region according to an embodiment;

FIG. 13 is a diagram explaining how a control is performed in accordance with a pixel arrangement (pixel pitch) according to an embodiment;

FIG. 14 is a diagram explaining how a view region is controlled by moving, rotating, or deforming the image displaying device according to an embodiment; and

FIG. 15 is a diagram explaining the density of light beams, which changes in accordance with the parallax number according to an embodiment.

### DETAILED DESCRIPTION

In general, according to an embodiment, a stereoscopic image displaying apparatus is configured to display a multi-viewpoint image. In the apparatus, an acquirer acquires person data including a position of each of persons who are viewing a stereoscopic image, a calculator calculates a weight from the person data and display parameters (the weight representing a stereoscopic degree inferred, for each of the persons, from a multi-viewpoint image to be displayed in accordance with the display parameters), a determiner selects the display parameter based on the weights and generates a multi-viewpoint image that accords with the display parameters selected, and a displaying device displays the generated multi-viewpoint image.

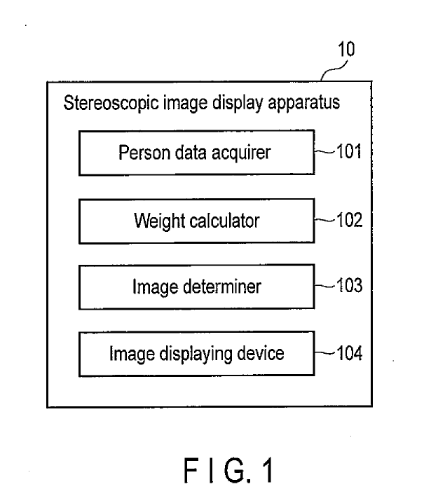

As shown in FIG. 1, a stereoscopic image display apparatus 10 according to an embodiment comprises a person data acquirer 101, a weight calculator 102, an image determiner 103, and an image displaying device 104. The apparatus 10 can change the mode of displaying a stereoscopic image in accordance with the positions of viewers and can enable, for example, several viewers to see a good stereoscopic image at the same time. The person data acquirer 101 detects the positions of the viewers (hereinafter called “persons”) who are viewing the stereoscopic image which the stereoscopic image display apparatus 10 displays. This embodiment can cope with the case where several persons view an image, and can detect the position of each of these persons. The person data acquirer 101 outputs the person data representing the detected position of each person. A detector, such as a camera, may detect the position of a person i, thus finding the coordinates (hereinafter referred to as “position coordinates Xi, Yi”) of the position that the person assumes with respect to the stereoscopic image display apparatus 10. The weight calculator 102 calculates a weight representing the stereoscopic degree for each person, from the person data acquired by the person data acquirer 101. The person data may include the position of the person. The image determiner 103 selects the display parameters at which the sum of weights the weight calculator 102 has calculated for each person is maximal. The image determiner 103 generates the multi-viewpoint image that accords with the display parameters selected. The image displaying device 104 displays the multi-viewpoint image output from the image determiner 103.

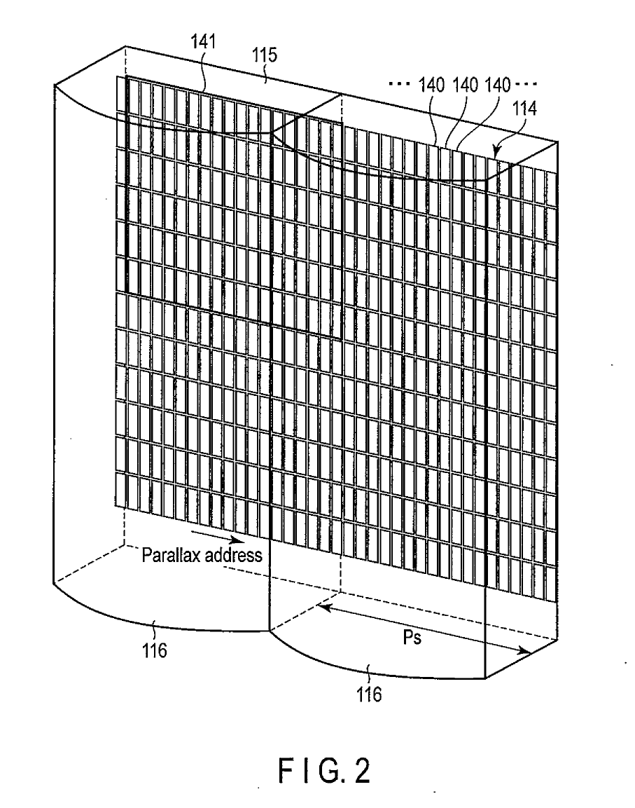

The image displaying device 104 may be a device configured to display the multi-viewpoint image generated by the image determiner 103. FIG. 2 is a perspective view schematically showing an exemplary configuration of the image displaying device 104. Assume that 18 viewpoints exist, that is, n=18. As shown in FIG. 2, the image displaying device 104 comprises a display element array 114 and an aperture controller 115 arranged in front of the display element array 114. A liquid crystal display (LCD) may be used as the display element array 114.

The aperture controller 115 is a light-beam control element that controls the light beams being transmitted and guides the light beams in a prescribed direction. As shown in FIG. 2, a lenticular sheet may be used as the aperture controller 115. The lenticular sheet is an array plate of lens segments, which controls the input light beams and output light beams, guiding them in a prescribed direction. Alternatively, an array plate having slits, i.e., light-transmitting regions, can be used as the aperture controller 115. These light-transmitting regions and lens segments have a function of emitting those of the light beams emerging forwards from the display element array 114, which propagate in a specific direction. Hereinafter, the lens segments and the light-transmitting regions will be collectively referred to as “optical aperture.”

As just explained, a lenticular sheet may be used as the aperture controller 115. The lenticular sheet is a lens array used in the display element array 114. Each of the lenses has a genetratrix extending perpendicular to the screen. The optical apertures 116, 116, . . . of the respective lens segments are arranged in association with pixels. The aperture controller 115 is not limited to such a lenticular lens sheet as described above or an array plate composed of light-transmitting regions. Instead, an LCD can be used as a light shutter that can change the position and shape of each light-transmitting region.

In any flat panel display (FPD) of the ordinary type, one pixel is composed of sub-pixels for red, green, and blue, (RGB) respectively. Assume that one display pixel corresponds to one sub-pixel. In the case shown in FIG. 2, the display element array 114 has display pixels (sub-pixels 140, 140, . . . ) arranged in the form of a matrix 141, each of the sub-pixels 140 having an aspect ratio of 3:1 so that the matrix 141 may be shaped like a square. Each sub-pixel 140 emits red (R) light, green (G) light, or blue (B) light. With respect to the row direction, an image defined by sub-pixels 140 arranged in the row direction, in the number associated with parallax, i.e., a set of parallax images represented by the sub-pixels 140 associated with an exit pupil (i.e., optical aperture 116), shall be called an “element image” (not shown). Note that the sub-pixels 140 are not limited to those for red, green, and blue (RGB).

With respect to the column direction, the element image is composed of six sub-pixels 140 arranged in the column direction. That is, one element image may be defined by 18 pixels arranged in the row direction and six pixels arranged in the column direction (as indicated by matrix 141 in FIG. 2). As seen from FIG. 2, a stereoscopic image can be displayed, which achieves 18 parallaxes in the horizontal direction, and the element image, i.e., pixels defining the stereoscopic image, becomes square because the six pixels are arranged in the column direction. The position any sub-pixel 140 assumes in one valid pixel in the horizontal direction corresponds to the aperture controller 115, and is correlated to the angle at which a light beam is emitted. The address representing the direction of the light beam shall be called “parallax address.” The parallax address corresponds to the position the sub-pixel 140 assumes, in one valid pixel, with respect to the horizontal direction. The parallax address gradually increases toward the right edge of the screen.

In the aperture controller 115, the optical apertures 116, 116, . . . are arranged at the element images, respectively. In the case shown in FIG. 2, the width Ps (lens pitch) of any optical aperture 116 is equal to the width of one element image.

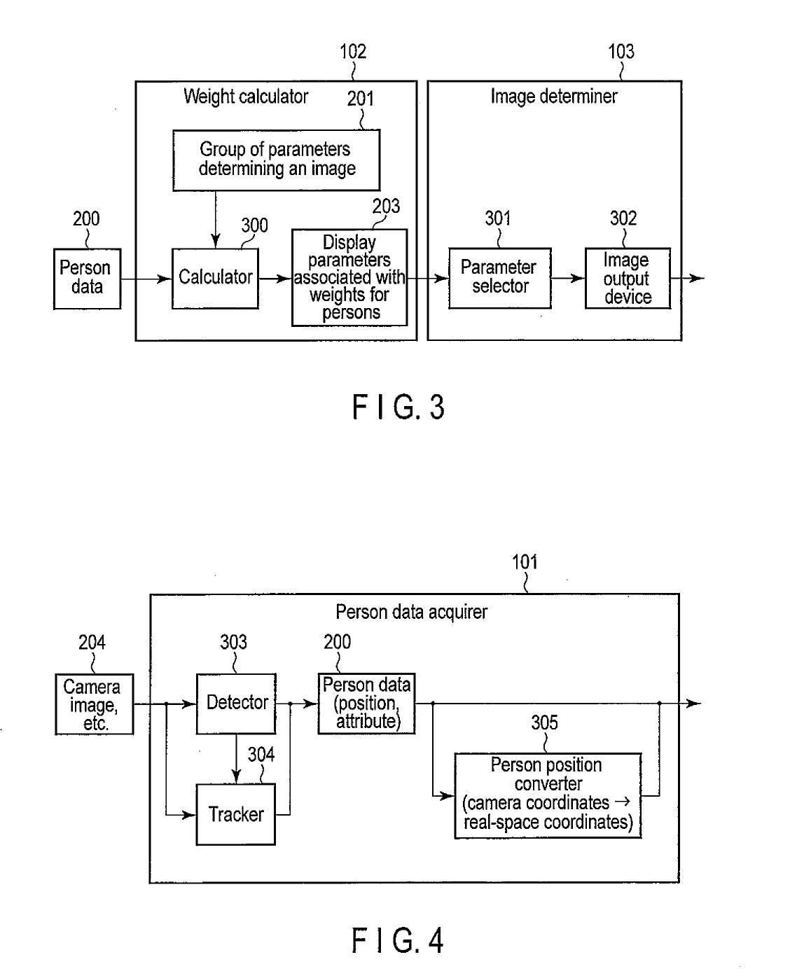

FIG. 3 schematically shows the configurations of the weight calculator 102 and image determiner 103. The weight calculator 102 has a calculator 300. The calculator 300 receives person data 200 containing the data acquired by the person data acquirer 101 and representing the position of each person, and also receives parameters for determining images. The calculator 300 calculates the weight representing the stereoscopic degree for each person. The calculator 300 outputs the weight about the person and display parameters 203 associated with the weight.

A weight W representing a stereoscopic degree of quality may be calculated by the calculator 102 from person data 200 for the multi-viewpoint image (i.e., combination of pixels) to display at the image display apparatus 10 and for a group of parameters 201 related to the hardware design of the image display apparatus 10. The greater the weight W, the better will be the quality of the resultant stereoscopic image. The weight W, which is based at least on the position of each person, may be changed in any manner. For example, it may be changed in accordance with any one of viewing modes the viewer has selected. The objects that can be controlled in accordance with the display parameters, such as the arrangement of pixels to display, will be described later in detail.

Consistent with an embodiment, a value of a position weight and that of an attribute weight are synthesized, generating the weight W. The position weight is calculated, which accords with the area of stereoscopic display, the density of light beams, and the position designated. The position data about each person may be acquired by any means. According to an embodiment, an attribute weight associated with the attribute of each person may also be calculated in addition to the position weight. As used herein, the attribute of each person may include identification data.

The image determiner 103 comprises a parameter selector 301 and an image output device 302. The parameter selector 301 receives the weight of each person and the display parameters 203 associated with this weight, and selects a display parameter that maximizes the total sum of the weights of persons, which the weight calculator 102 has calculated. The image output device 302 outputs the multi-viewpoint image that accords with the display parameter selected by the parameter selector 301.

An exemplary configuration of the image display apparatus 10 consistent with an embodiment will be described in more detail.

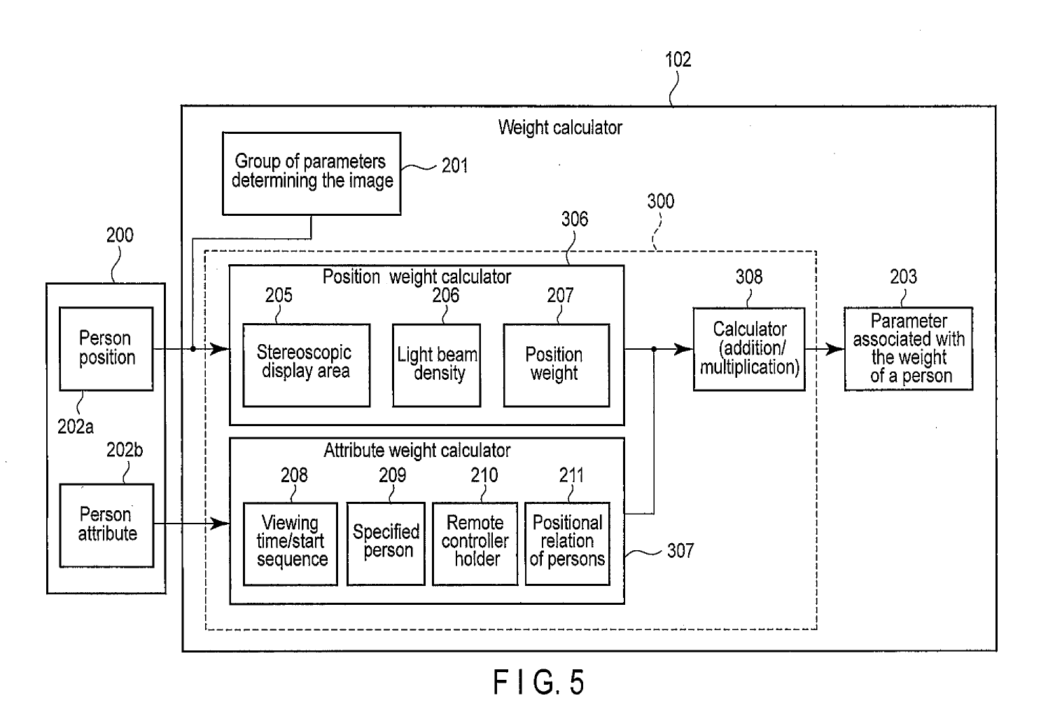

FIG. 4 shows the configuration of the person data acquirer 101 consistent with an embodiment. The person data acquirer 101 comprises a detector 303 and a tracker 304. The detector 303 receives a camera image 204 or the like, detects the position of each person, and outputs the person data 200 representing the position of each person. As shown in FIG. 4, the detector 303 may also output the attribute data of each person. The tracker 304 detects the change in the position of the same person for a prescribed time, from the output of the detector 303. That is, the tracker 304 tracks each person moving.

The image used to detect the position of each person is not limited to an image coming from a camera. A signal provided from, for example, radar may be used instead. Any object that can be recognized as pertaining to a person, e.g., face, head, entire person or marker, may be-detected in order to detect the position. As the attribute of each person, the name, child/adult distinction, viewing time, remote controller ownership, or the like can be exemplified. The attribute is detected by any means or by may be explicitly input by the viewer or someone else.

The person data acquirer 101 may further comprise a person position converter 305 configured to convert the position data about each person, to a coordinate value. The person position converter 305 may be provided not in the person data acquirer 101, but in the weight calculator 102.

FIG. 5 shows the configuration of the weight calculator 102 consistent with an embodiment. The weight calculator 102 comprises the calculator 300. The calculator 300 receives the person data 200 and the group of parameters 201 that determines an image, and calculates and outputs the weight of each person and the display parameter 203 associated with this weight. The calculator 300 comprises a position weight calculator 306, an attribute weight calculator 307, and a calculator 308. The position weight calculator 306 calculates a position weight from the parameter group that determines a person position 202a and the image. The attribute weight calculator 307 calculates an attribute weight from a person attribute 202b. The calculator 308 calculates the sum or product of the position weight and the attribute weight, so calculated. If only the position weight or the attribute weight is utilized, the sum or product of these weights need not be calculated.

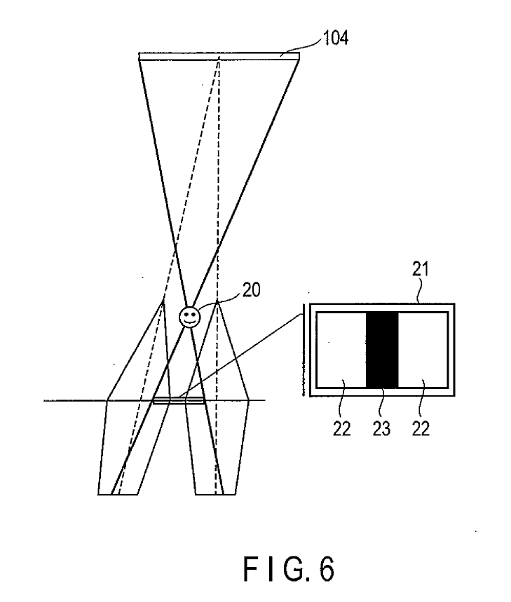

The position weight calculator 306 calculates the position weight from a stereoscopic display area 205, a light beam density 206, and a position weight 207. The stereoscopic display area 205 is determined from the position of each person (i.e., position relative to the display screen of the image display apparatus 10) and the multi-viewpoint image. The larger this area, the greater the position weight will be. Further, the light beam density 206 is determined from the distance from the display screen of the image display apparatus 10 and the number of viewpoints. The higher the light beam density 206, the greater the position weight will become. For the position weight 207, a greater weight is assigned to the usual viewing position than to any other positions. The position weight calculator 306 calculates the sum or product of the weights calculated for the stereoscopic display area 205, light beam density 206, and position weight 207, and outputs the sum or product. In the case where only one of these weights may be utilized, the sum or product of these weights need not be calculated. Moreover, any other item that can represent a weight pertaining to a “viewed state” may be added. “Viewed state” will be explained with reference to FIG. 6 below.

The attribute weight calculator 307 calculates the attribute weight from attribute values such as the viewing time or a start sequence 208 and a specified person 209, a remote controller holder 210 and a positional relation of persons 211. Higher weights are assigned to the viewing time and start sequence 208 so that any person who has been viewing for a long time or has started viewing before anyone else may have priority. Similarly, the weight for the specified person 209 or holder 210 of the remote controller is increased so that the specified person 209 or holder 210 may have priority. As for the positional relation 211, a person sitting in front of the display or near the display has a greater weight than any other persons. The attribute weight calculator 307 finds the sum or product of the weights calculated for the viewing time and start sequence 208, specified person 209, remote controller holder 210 and positional relation 211, and outputs the sum or product. If only one of these weights is utilized, the sum or product of these weights need not be calculated. Further, any other item that can represent a weight pertaining to viewing may be added.

Further, the calculator 308 calculates the sum or product of the weight value output from the position weight calculator 306 and the attribute weight value output from the attribute weight calculator 307.

Unless the parameters are selected on the basis of only the data about the specified person 209, the calculator 308 must calculate at least the position weight. In addition, the weight may be calculated for each person and may be based on each of the display parameters included in the display parameters 201 that determine the image. As a rule, weights are calculated for all persons (except for the case where the parameters are selected for the specified person 209 only).

How weights are calculated from the area of the stereoscopic display area 205 will be explained with reference to FIG. 6. A “viewed state” can be geometrically found or calculated. The pattern 21 extracted at a view region setting distance by the two lines connecting a person 20 to the two edges of the image displaying device (display) 104, is identical to the “viewed state.” In the case shown in FIG. 6, the parts 22 of the pattern 21 are regions in which stereoscopic views can be seen, while part 23 of the pattern 21 is a region in which no stereoscopic views can be seen. The ratio of these parts 22 to the entire pattern 21 can be calculated as a weight. The ratio of the parts 22 may be, for example, 100%. In this case, the entire pattern 21 is seen as a stereoscopic image, and the weight calculated has the maximum value of, for example, “1.”

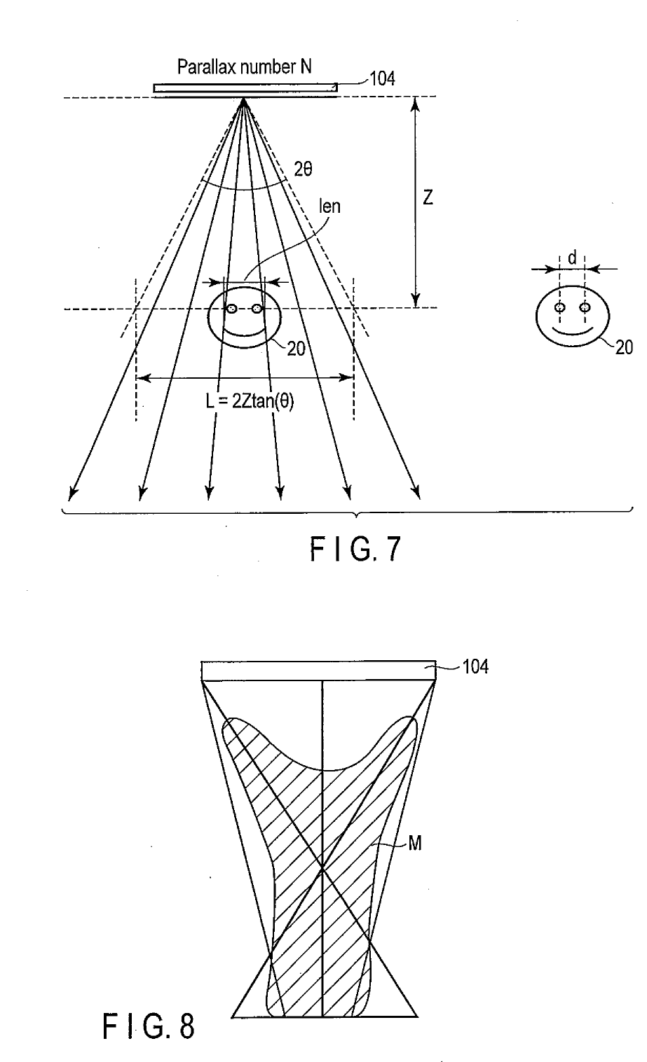

How weights are calculated from the area of the light beam density 206 will be explained with reference to FIG. 7. The weight of the light beam density 206 can be calculated by the following equation:

$$L = 2 Z tan ( θ ) \\ {w}_{ray} ( z ) = \{ \begin{matrix}1 & if z < \frac{dN}{2 tan ( θ )} \\ \frac{d}{L / N} & othewise\end{matrix} \qquad ( 1 )$$

where N is the parallax number, 2θ is the diversion angle of the light beam, Z is the distance from the display 104 to the person 20, and d is the inter-eye distance of the person 20.

That is, the ratio of the width “len” of the light beam to the inter-eye distance d is regarded as the weight of the light beam density 206. If the width len of the light beam is smaller than the inter-eye distance d, the weight of the light beam density 206 will be set to the value of “1.”

FIG. 8 shows an exemplary weight map M, in which the weight value calculated by the calculated by the weight calculator 102 are distributed in the real-space coordinates.

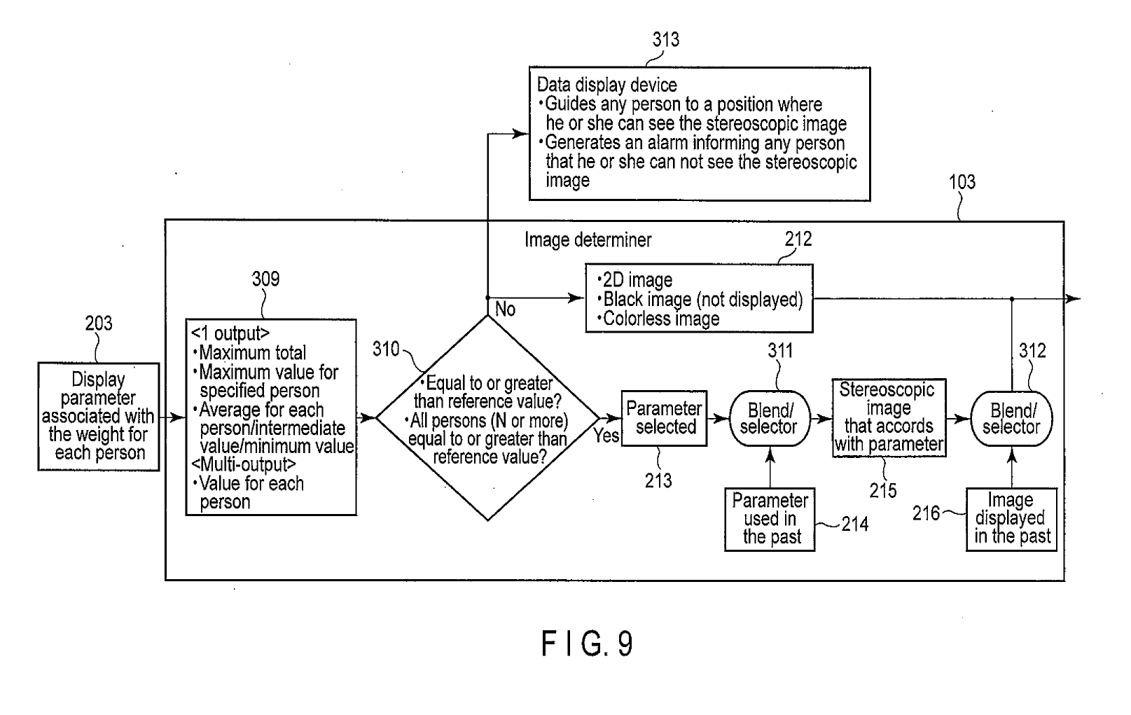

FIG. 9 shows the configuration of the image determiner 103. The image determiner 103 receives the weight of each person, output from the weight calculator 102, and also the display parameter 203 associated with this weight. The weight of each person and the display parameter may be either a single output or a plurality of outputs. If the image determiner 103 receives a single output, the output may be the maximum total value of weights for each person, the maximum value for the specified person, or the average value or intermediate value for each person, whichever is greater. Alternatively, different priorities may be allocated to the viewers in accordance with their attribute weights, and the maximum value of the total weight for the viewers having priorities higher than a specific value, or the average or intermediate value of the weights for the viewers, whichever is greater.

The decisioner 310 of the image determiner 103 determines whether the weight described above is equal to or greater than a prescribed reference value. If the decisioner 310 receives a plurality of outputs, it determines whether the weights of all viewers (or N viewer or more viewers) are equal to or greater than the reference value. Instead, different priorities may be allocated to the viewers in accordance with their attribute weights, and the decisioner 310 may determine whether the weights of only the viewers having priorities are higher than a particular value. In either case, a display parameter 213 associated with any weight equal to or greater than the reference value is selected. In order to increase the visibility at the time of switching the image, the display parameter selected this time is slowly blended with the display parameter 214 used in the past, gradually changing the display parameter on the basis of the display parameter 214. The image determiner 103 may have a blend/selector 311 that switches images if the scene changes so fast or the image moves so fast that the change can hardly be recognized. In order to enhance the visibility at the time of switching the image, the image determiner 103 may further have a blend/selector 312 that blends a multi-viewpoint image (stereoscopic image) 215 with an image 216 displayed in the past, thereby slowing the changing of the scene. In the process of blending the images, it is desired that a primary delay should be absorbed.

Alternatively, the presentation of the multi-viewpoint image (stereoscopic image) that accords with the selected display parameter can be achieved by physically changing the position or orientation of the image displaying device 104 as will be described later.

If the weight determined by the decisioner 310 of the image determiner 103 has a value smaller than the reference value, an image 212, such as a two-dimensional image, monochromic image, black image (not displayed) or colorless image, will be displayed (that is, a 2D image is displayed), in order not to display an inappropriate stereoscopic image. The 2D image will be displayed if the total sum of weights is too small, if some of the viewers are unable to see the stereoscopic image, or if the visibility is too low for the specified person. In this case, the image determiner 103 may further have a data display device 313 that guides any person to a position where he or she can see the stereoscopic image or generates an alarm informing any person that he or she cannot see the stereoscopic image.

The controls achieved by the display parameters 201 that determine an image will be explained. Some of the display parameters control the view region, and the other display parameters control the light beam density. The parameters for controlling the view region are the image shift, the pixel pitch, the gap between each lens segment and the pixel associated therewith, and the rotation, deforming and motion of the display. The parameters for controlling the light beam density are the gap between the each lens segment and the pixel associated therewith and the parallax number.

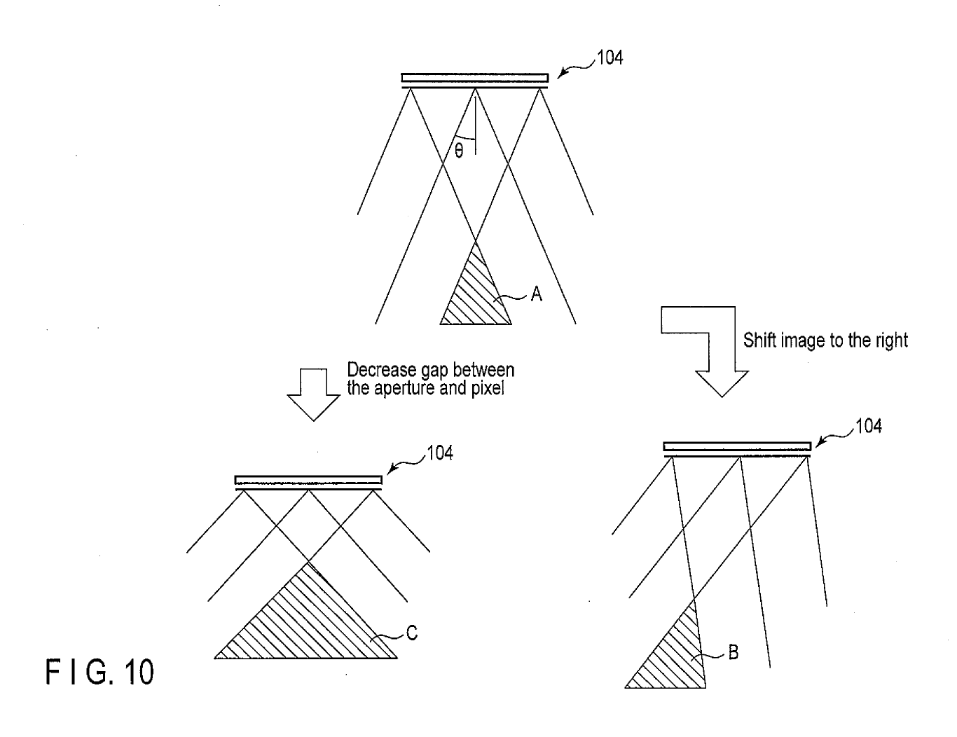

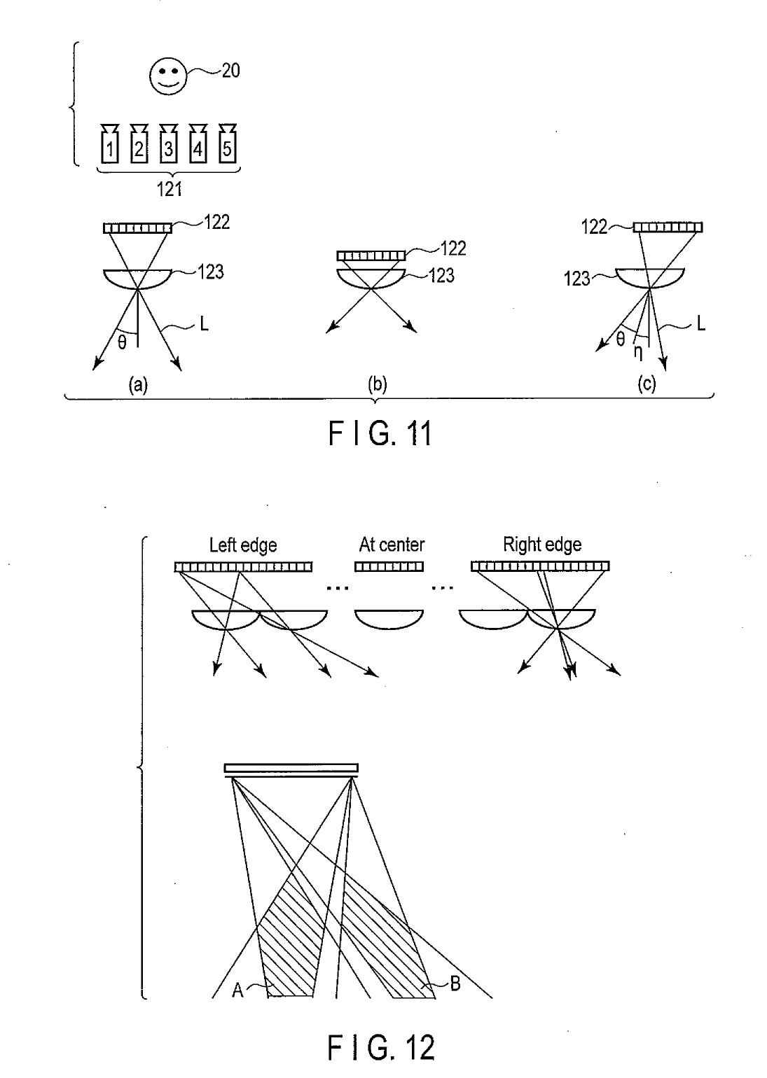

The display parameters for controlling the view region will be explained with reference to FIG. 10 and FIG. 11. If the image displayed is shifted to, for example, the right, the “view region,” i.e., region where the stereoscopic image can be seen well, will move from region A to region B, as shown in FIG. 10. As seen from the comparison items (a) and (c) shown in FIG. 11, the view region shifts to the left, or moves to region B, because the light beam L shifts to the left as shown at item (c).

If the gap between the pixel 22 and the lens/slit 23 (optical aperture 116 shown in FIG. 2) is shortened, the view region will move from region A to region C, as can be understood by comparing items (a) and (b) shown in FIG. 11, in which the pixel 22 and the lens/slit 23 are represented as a pixel 122 and a lens/slit 123, respectively. In this case, the light beam density decreases, though the view region gets nearer.

As shown in FIG. 11, parallax images are sequentially arranged at the pixels 122 of the display in a specific order. The parallax images are images, each deviating from the view point. They are equivalent to the images of a person 120, photographed with a plurality of cameras 121, respectively, as shown in FIG. 11. The light beam emerges from the pixel 122 (sub-pixel 140) and passes through the lens/slit 123 (optical aperture 116 shown in FIG. 2). The shape of the view region can be geometrically determined, by using angles θ and η shown in FIG. 11.

The adjacent view regions will be explained with reference to FIG. 12. The view region B adjacent to view region A in which the image is viewed is defined by the left pixel and the lens on the right side of the leftmost lens and the pixel and by the right pixel and the lens on the left side of the rightmost lens. The view region B can be further shifted to the left or the right.

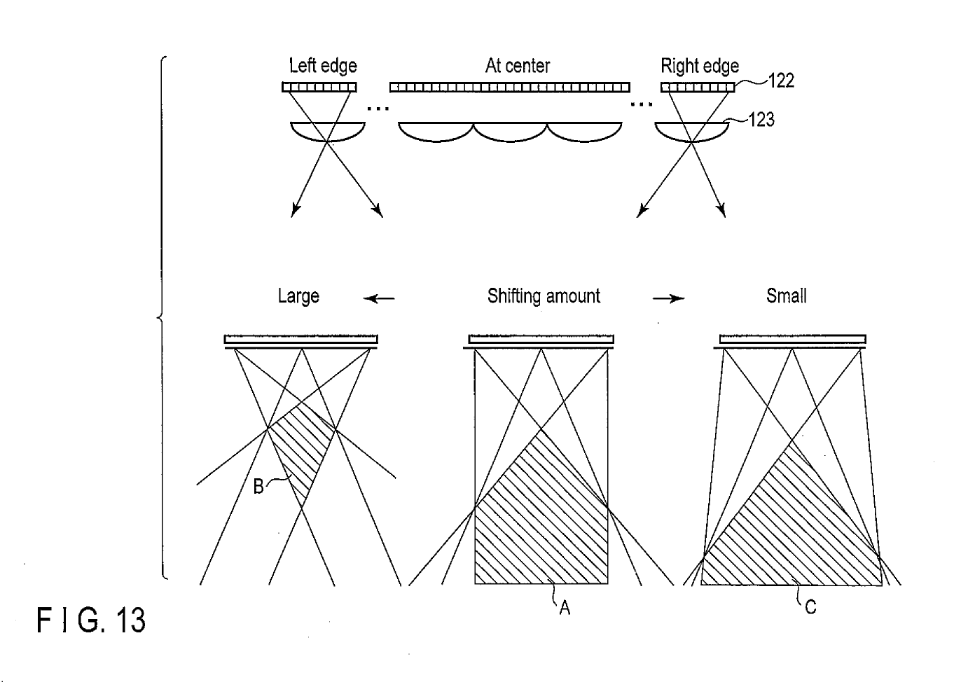

How a control is performed in accordance with a pixel arrangement (pixel pitch) will be explained with reference to FIG. 13. At either edge (i.e., left edge or right edge) of the screen, the view region can be better controlled by shifting the pixel 122 and the lens 123 relative to each other. If the pixel 122 and the lens 123 are much shifted relative to each other, the view region will change from view region A to the view region B as shown in FIG. 13. Conversely, if the pixel 122 and the lens 123 are shifted relative a little to each other, the view region will change from view region A to the view region C as shown in FIG. 13. The width and nearness of the view region can thus be controlled in accordance with the display parameter related to the pixel arrangement (pixel pitch). The distance at which the view region is broadest shall be called “view-region setting distance.”

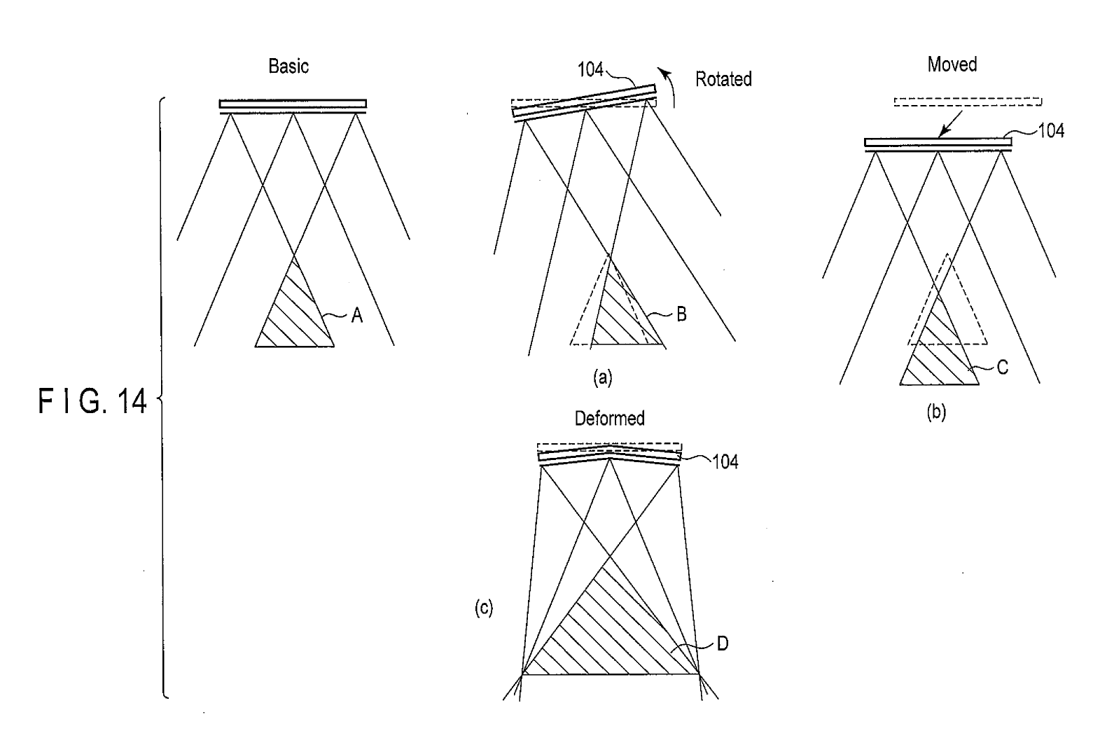

How the view region is controlled by moving, rotating or deforming the image displaying device 104 will be explained with reference to FIG. 14. As shown in item (a) of FIG. 14, the basic view region A can be changed to view region B by rotating the image displaying device 104. Similarly, the basic view region A can be changed to view region C by moving the image displaying device 104, and to view region D by deforming the image displaying device 104. Thus, the view region can be controlled by moving, rotating or deforming the image displaying device 104, thereby controlling the view region.

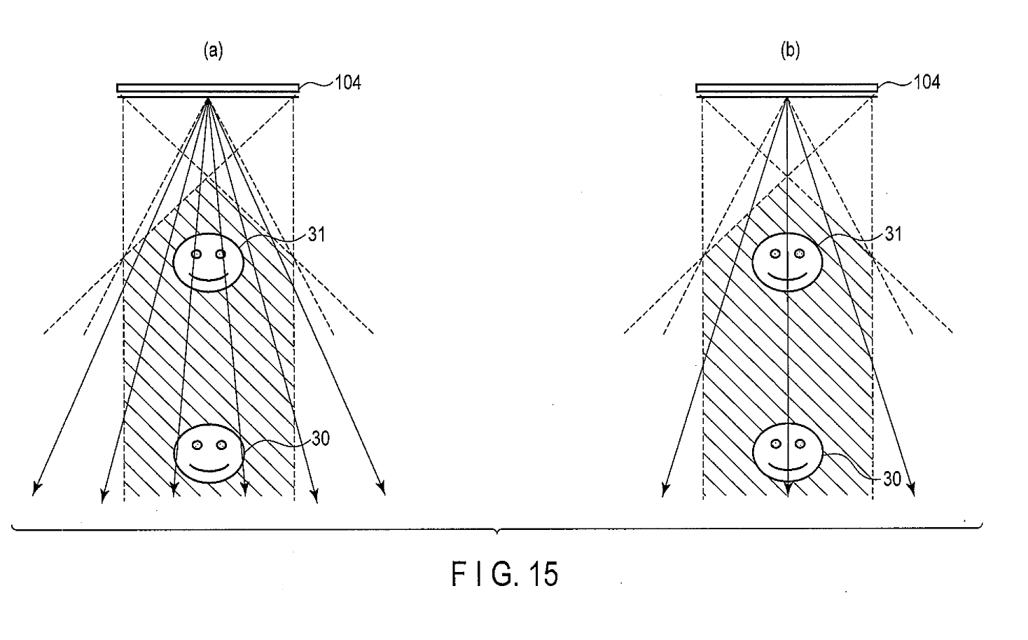

With regard to the display parameters controlled in connection with the light beam density, how the light beam density changes in accordance with the parallax number will be explained with reference to FIG. 15.

If the parallax number is 6 as shown in item (a) of FIG. 15, a person 31 closer to the display 104 than a person 30 receives more light beams and can therefore see a better stereoscopic image than the person 30. If the parallax number is 3 as shown in item (b) of FIG. 15, reducing the light beam density, the person 31 receives less light beams than in the case shown in item (a) of FIG. 15 so long as the person remains at the same distance from the display device 104. The density of the light beams emitted from each pixel of the display device 104 can be calculated from the angle θ determined by the lens and the gap, the parallax number and the position of the person.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for displaying a stereoscopic image, comprising:
an acquirer configured to acquire person data including a position of each of at least one person viewing a stereoscopic image;
a calculator configured to calculate a weight for each of the at least one person from the person data for a display parameter, the weight representing a stereoscopic degree inferred, for each of the at least one person, from a multi-viewpoint image to be displayed in accordance with the display parameter;
a determiner configured to select the display parameter based on the calculated weight, and generate a multi-viewpoint image that accords with the display parameter selected; and
a displaying device configured to display the generated multi-viewpoint image.

2. The apparatus according to claim 1, wherein the determiner selects the display parameter that maximizes a total sum of the weights for each of the at least one person, respectively.

3. The apparatus according to claim 1, wherein the calculator calculates the weight that accords with an area of a stereoscopic view region at the position of each of the at least one person.

4. The apparatus according to claim 1, wherein the calculator calculates the weight that accords with a density of light beams at the position of each of the at least one person, the light beams having been emitted from each pixel of the displaying device.

5. The apparatus according to claim 1, wherein the calculator calculates a first weight that accords with an area of a stereoscopic view region at the position of each of the at least one person and a second weight that accords with a density of light beams at the position of each of the at least one person, and calculates the weight for each of the at least one person by performing an operation on the first weight and the second weight.

6. The apparatus according to claim 5, wherein the calculator calculates the weight for each of the at least one person by performing addition or multiplication on the first weight and the second weight.

7. The apparatus according to claim 3, wherein the acquirer further acquires attribute data about each of the at least one person, and the calculator calculates the weight that accords with the position of each of the at least one person and the attribute data.

8. The apparatus according to claim 3, wherein the determiner outputs a 2D image if the total sum of the weights is not equal to or greater than a reference value.

9. The apparatus according to claim 1, wherein the display parameter includes a parameter that changes the arrangement of pixels of the multi-viewpoint image to display at the displaying device.

10. A method for displaying a stereoscopic image, comprising:
acquiring person data including a position of each of the at least one person viewing a stereoscopic image;
calculating a weight for each of the at least one person from the person data for a display parameter, the weight representing a stereoscopic degree inferred, for each of the at least one person, from a multi-viewpoint image to be displayed in accordance with the display parameter;
selecting the display parameter based on the calculated weight, and generating a multi-viewpoint image that accords with the display parameter selected; and
displaying the generated multi-viewpoint image.
